(19) United States
(12) Patent Application Publication
(10) Pub. No.: US 2021/0289980 A1
(43) Pub. Date: Sep. 23, 2021

(54) BREWING EXTRACTION EQUIPMENT

(71) Applicant: SHENZHEN QUANTUM DEEP EXTRACT TECHNOLOGY CO., LTD, Shenzhen, Guangdong (CN)

(72) Inventor: YI ZHAN, Shenzhen, Guangdong (CN)

(21) Appl. No.: 17/266,868

(22) PCT Filed: Aug. 20, 2019
(86) PCT No.: PCT/CN2019/101614

§ 371 Date: Feb. 8, 2021

(30) Foreign Application Priority Data
Aug. 27, 2018 (CN) 201810983714.7

(51) Int. Cl. A47J 31/36; A47J 31/46; A47J 31/54

(52) U.S. Cl. CPC A47J 31/3609; A47J 31/54; A47J 31/468; A47J 31/461

(57) ABSTRACT

Disclosed is brewing extraction equipment, including a cylinder, a piston, a pressure rod, a connecting rod, a kettle body, a first one-way valve, a second one-way valve, a water separator and a powder bowl. The pressure rod comprises a pressure rod head and a pressure rod handle, the kettle body comprises a water tank, a first pipe and a second pipe. The connecting rod is connected to the pressure rod head, the pressure rod head is connected to one end of the piston, the piston is arranged inside the air cylinder, the water tank is connected to the bottom of the cylinder via the first pipe, the first one-way valve is located inside the first pipe, the air cylinder is further connected to the water separator via the second pipe located at the bottom thereof, and the second one-way valve is located inside the second pipe. The brewing extraction equipment enables a user to obtain huge liquid pressure and liquid pressure intensity by easily applying a force, so as to extract high-quality espresso coffee. And the equipment is small, lightweight and detachable, and is easy to carry.

### CROSS-REFERENCE TO RELATED APPLICATIONS

This application claims priority to Chinese Patent Application NO. 201810983714.7 filed on Aug. 27, 2018, entitled brewing extraction equipment, the contents of which are all incorporated herein by reference in their entireties.

### BACKGROUND OF THE INVENTION

### Field of the Invention

The present application relates to the technical field of machinery, in particular to a brewing extraction equipment.

### Description of the Related Art

Coffee is a beverage made by brewing coffee powder and extracting some of its material components. It is the main drink popular in the world like cocoa and tea. In modern society, a variety of equipment, such as espresso coffee machine, American electric coffee machine, siphon pot, moka pot and hand cup, can be used to brew and extract coffee.

Among them, the existing espresso machine can produce espresso. It provides sufficient water pressure through an electric water pump, so that hot water passes through the compacted coffee powder to extract the espresso. It needs to be connected to a power supply, and the volume is relatively large and heavy, which is not convenient to carry.

On the other hand, the existing pressurized manual espresso coffee making equipment usually uses a pressing rod and a piston with a pressurized area close to the opening surface of the coffee powder bowl to manually press hot water directly into the powder bowl at once. And through the coffee powder in the powder bowl, the coffee liquid is obtained. Because the piston has a large pressurizing area, the pressurization is laborious, and it is difficult to obtain sufficient pressure for extracting espresso. The machine is often heavy and bulky, and the work of adding water and coffee powder is cumbersome.

### SUMMARY

The present application provides a brewing extraction device, which uses a piston with a smaller pressurized area and a corresponding cylinder, and two one-way valves to pump hot water into a coffee powder bowl in a small amount for multiple times to solve the existing problem. Due to the large pressurizing area of the pressurized water piston, the pressurized manual espresso coffee making equipment caused problems such as laborious pressurization, difficulty in obtaining sufficient pressure for extracting espresso, heavy and bulky machines, and cumbersome addition of water and powder. In addition, this equipment can integrate brackets, covers, heating devices, constant pressure water valves, water pressure gauges and other accessories to realize the functions of hanging the powder bowl, easy fixing, self-heating, setting and keeping the liquid pressure constant, and real-time monitoring of the liquid pressure. In order to solve the above problems, the present application discloses a brewing extraction equipment, including: a cylinder, a piston, a pressure rod, a connecting rod, a kettle body, a first one-way valve, a second one-way valve, a water separator and a powder bowl; the pressure rod includes a pressure rod head and a pressure rod handle; the kettle body includes a water tank, a first pipe and a second pipe.

The connecting rod is connected to the head of the pressing rod; the head of the pressing rod is connected to one end of the piston, the piston is arranged in the cylinder, the water tank is connected to the bottom of the cylinder through the first pipe, the first one-way valve is located in the first pipe, the cylinder is also connected to the water separator through the second pipe provided at the bottom, and the second one-way valve is located in the second pipe.

When the plunger handle is pulled up, the plunger head drives the piston to move upward in the cylinder, and the liquid in the water tank flows to the cylinder through the first one-way valve under the action of atmospheric pressure. The second one-way valve is closed; when the pressing rod handle is pressed down, the head of the pressing rod drives the piston to move down in the cylinder, and the liquid in the cylinder is pressurized to flow through the second one-way valve to water diversion, and at the same time, the first one-way valve is closed; the liquid flows into the powder bowl after being dispersed by the water separator; the liquid soaks the compacted brewing materials in the powder bowl to obtain the extract.

Preferably, the brewing extraction equipment further includes a bracket; the bracket is arranged outside the bottom of the kettle body; the bracket is used to fix and support the main part of the brewing extraction equipment.

Preferably, the brewing extraction equipment further includes a cover; the cover is arranged above the kettle body.

Preferably, the powder bowl is connected to the water divider, and the bottom of the powder bowl has at least one through hole; the powder bowl is used to fill the brewing material and pass the bottom through hole. The liquid is high-pressure filtered through the brewing material to obtain an extract.

Preferably, the brewing extraction equipment further includes a heating device; the heating device is provided at the bottom or side of the water tank and the heating device is used to heat the liquid in the water tank.

Preferably, the kettle body is also provided with a constant pressure water valve; the constant pressure water valve is connected to the second pipe; the constant pressure water valve is used to press down the lever handle, the pressure rod head drives the piston to move downward in the cylinder, and the pressure of the liquid in the cylinder is adjusted when the liquid in the cylinder flows to the water separator through the second one-way valve under pressure.

Preferably, the kettle body is further provided with a water pressure gauge; the water pressure gauge is connected to the second pipe; the water pressure gauge is used when the pressure rod handle is pressed down, the pressure rod the head drives the piston to move down in the cylinder, and the pressure of the liquid in the cylinder flows to the water separator through the second one-way valve under pressure, and the pressure of the liquid is measured.

This application includes the following advantages.

In this application, the brewing extraction equipment includes: a cylinder, a piston, a pressure rod, a connecting rod, a kettle body, a first one-way valve, a second one-way valve, a water separator and a powder bowl; the pressure rod includes a pressure a rod head and a pressing rod handle; the kettle body includes a water tank, a first pipe and a second pipe; the connecting rod is connected with the pressing rod head; the pressing rod head is connected with one end of the piston; the piston is arranged in the cylinder; the water tank is connected to the bottom of the cylinder through the first pipe; the first one-way valve is located in the first pipe; the cylinder is also arranged in it, the second pipe at the bottom is connected with the water separator; the second one-way valve is located in the second pipe.

In the present application, the brewing extraction equipment enables users to easily apply force to obtain huge liquid pressure and liquid pressure, and extract high-quality espresso coffee. The device is small and light, which can be disassembled and is easy to carry. The work of adding water and coffee powder is simple and convenient. There are few parts to be cleaned after use, and the cleaning work is simple and convenient. In addition, when the heating device is integrated, the liquid in the water tank can be heated and the kettle body is preheated; when the constant pressure water valve is integrated, the pressure of the liquid in the system can be set and kept constant to achieve extraction The diversity and consistency of the effects improve the fun of use and the extraction effect; when the water pressure gauge is integrated, the liquid pressure in the system can be observed in real time, and the extraction effect can be easily controlled.

### BRIEF DESCRIPTION OF THE DRAWINGS

In order to more clearly explain the technical solutions in the present application, the following will briefly introduce the drawings used in the description of the embodiments. Obviously, the drawings in the following description are only some implementations of the present application for example, for those of ordinary skill in the art, without paying any creative labor, other drawings can be obtained based on these drawings.

FIG. 1 is a structural block diagram of a brewing extraction equipment of the present application;

FIG. 2 is a schematic diagram of another state of the brewing extraction equipment of the present application;

FIG. 3 is a block diagram of a kettle body of the present application;

FIG. 4 is a structural block diagram of another brewing extraction equipment of the present application;

FIG. 5 is a structural block diagram of a bracket of the present application;

FIG. 6 is a structural block diagram of another brewing extraction equipment of the present application;

FIG. 7 is a schematic diagram of another state of the brewing extraction equipment of the present application;

FIG. 8 is a block diagram of the internal structure of a heating device of the present application;

FIG. 9 is a structural block diagram of the heating device of the present application on the inner side of the bottom of the water tank;

FIG. 10 is a structural block diagram of another brewing extraction equipment of the present application;

FIG. 11 is a structural block diagram of another brewing extraction equipment of the present application.

### DETAILED DESCRIPTION OF THE EMBODIMENTS

In order to make the technical problems, technical solutions, and beneficial effects solved by the present application clearer, the following further describes the present application in detail with reference to the accompanying drawings and embodiments. It should be understood that the specific embodiments described here are only used to explain the application, but not to limit the application.

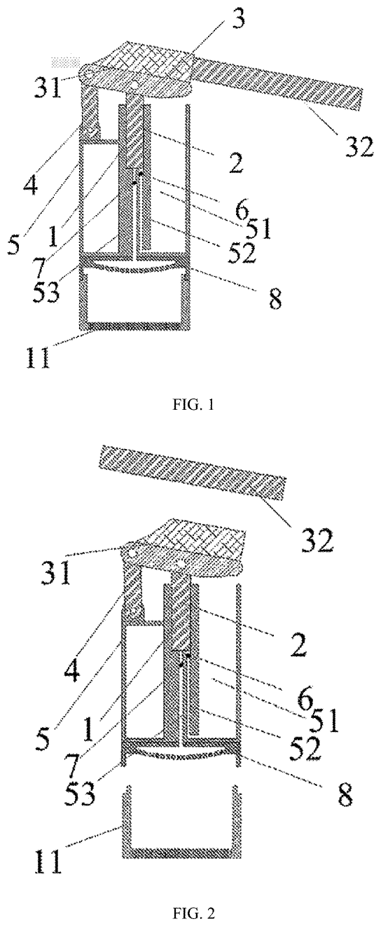

Referring to FIG. 1, there is shown a structural block diagram of a brewing extraction equipment of the present application, which may specifically include the following components: a cylinder 1, a piston 2, a pressure rod 3, a connecting rod 4, a kettle body 5, a first one-way valve 6, a second one-way valve 7, a water separator 8 and a powder bowl 11; the pressure rod 3 includes a pressure rod head 31 and a pressure rod handle 32; the kettle body 5 includes a water tank 51, a first pipe 52 and a second pipe53.

Specifically applied to the present application, the connecting rod 4 is rotatable, and the connecting rod 4 is connected with the pressure rod head 31, the pressure rod head 31 is connected with one end of the piston 2, the piston 2 is arranged in the cylinder 1, the water tank 51 is connected to the bottom of the cylinder 1 through the first pipe 52; the first one-way valve 6 is located in the first pipe 52, the cylinder 1 is also connected to the water separator 8 through the second pipe 53 provided at the bottom thereof; the second one-way valve 7 is located in the second pipe 53.

In a practical application of the present application, when the pressure rod handle 32 is pulled up, the connecting rod 4 rotates around the bottom fulcrum, and the pressure rod head 31 drives the piston 2 to move upward in the cylinder 1. The liquid in the water tank 51 flows to the cylinder 1 through the first one-way valve 6 under the action of atmospheric pressure, while the second one-way valve 7 is closed; when the pressure rod handle 32 is pressed down, the connecting rod 4 rotates around the bottom fulcrum, the pressure rod head 31 drives the piston 2 to move down in the cylinder 1, and the liquid in the cylinder 1 flows to the water separator 8 through the second one-way valve 7 under pressure, and the first one-way valve 6 is closed; the liquid flows into the powder bowl 11 after being dispersed by the water separator 8; the liquid soaks the compacted brewing materials in the powder bowl 11, and filters the compacted brewing materials under sufficient pressure and extracts them at the same time some of these substances flow out through the through holes at the bottom of the powder bowl 11 to obtain the extract. The brewing ingredients can be placed in the powder bowl 11 in advance, and the powder bowl 11 is connected to the water separator 8.

Regardless of the direction of movement of the piston and the direction of the pressure acting on the liquid, the above-mentioned first one-way valve 6 allows the liquid in the first pipe 52 to flow only in the direction of entering the cylinder 1, and the second one-way valve 7 allows the liquid in the second pipe 53 to flow only in the direction away from the cylinder 1, thereby ensuring that the liquid in the system always moves along the direction of “tank-cylinder-water separator” during the reciprocating movement of the piston 2, without backflow.

It should be noted that the cylinder 1 and the piston 2 and two one-way valves can cooperate with each other to achieve multiple pumping of liquid into and out of the cylinder 1; that is, the piston 2 has a fixed stroke range the cylinder 1 moves inside, and this application does not impose excessive restrictions on the dimensions of the cylinder 1, such as diameter and depth.

On the other hand, the piston 2 may be a structure of an extruded rubber ring plus a piston rod (that is, an extruded rubber ring is provided at the head of the piston rod as a seal). In addition, the piston 2 may also be a single frosted glass or surface-treated metal or polymer material and other materials that do not rely on a rubber ring but can play a sealing role by itself (or other shapes), and can also be other forms of piston design structures. This application does not specifically limit the material and structure of the piston 2.

Further, the connecting rod 4 is connected to the pressure rod head 31, the pressure rod head 31 is connected to one end of the piston 2. The connecting rod 4 and its bottom fulcrum, the pressure rod 3, the cylinder 1 and the piston 2 together form a structure similar to a “compound lever”, which has a labor-saving effect. According to the pascal principle, the water pressure on the brewing material is equal to the water pressure generated in the cylinder 1, and under the same pressure, the smaller the pressure area, the greater the pressure. The diameter of the cylinder 1 and the piston 2 are so set (that is, a smaller cylinder 1 and piston 2 diameter is set) that a huge pressure can be easily obtained in the cylinder 1 by pressing the pressure rod 3 to drive the piston 2, and thereby making the liquid on the brewing material in the powder bowl obtain a huge pressure. Therefore, the user does not need to apply a large pressure to the device to obtain a sufficient pressure for extracting espresso. Since the pressure exerted by the hand is small, there is no need to increase the volume and weight of the device to obtain sufficient stability, realizing the design effect of compact structure and portability of the product, and improving the user's operation convenience.

Referring to FIG. 2, there is shown a schematic diagram of another state of the brewing extraction device of the present application. The pressure rod handle 32 is detachable to facilitate carrying and the material of the connecting rod 4 and the pressure rod 3 is without too much restriction, for example, the material of the connecting rod 4 and the pressure rod 3 can be plastic or metal. In addition, this application does not limit the shape of the pressure rod handle and whether it is a single-section design structure or a splicable multi-section design structure.

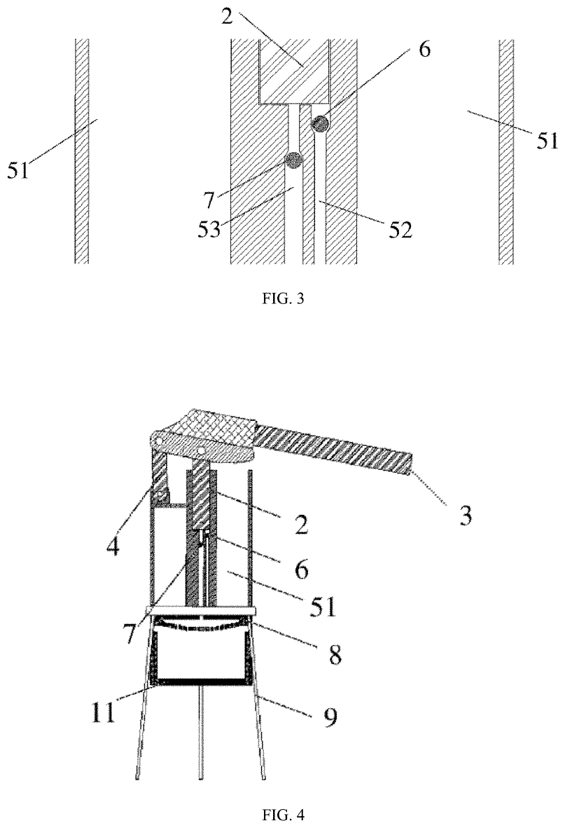

Referring to FIG. 3, there is shown a partial structural block diagram of a kettle body 5 of the present application. The kettle body 5 may include a water tank 51, a first pipe 52 and a second pipe 53, and the first one-way valve 6 may be set in the first pipe 52, the second one-way valve 7 may be set in the second pipe 53.

The water tank 51 is provided in the annular space between the cylinder 1 and the outer wall of the kettle body. The present application does not limit the location of the water tank 51, that is, the location of the water tank 51 can be determined by those skilled in the art according to actual conditions. Set any position, and because the liquid in the water tank 51 is pumped into the cylinder and then into the powder bowl through the cylinder 1 plus the piston 2 plus the one-way valve, instead of being directly pressed into the powder bowl through the piston as in many existing products, it means that the liquid in the water tank does not need to be pressurized, so the water tank can be designed as an open type or a capped type that does not need to be sealed, so that the work of adding water is easy and simple.

It should be noted that the types of the first one-way valve 6 and the second one-way valve 7 can include spring one-way valves, gravity one-way valves, swing one-way valves, and plastic diaphragm one-way valves. For example, the present application does not limit the types of the first one-way valve 6 and the second one-way valve 7 too much.

When the user pulls up the pressure rod handle 32, the connecting rod 4 rotates around the bottom fulcrum, the pressure rod head 31 drives the piston 2 to move upward in the cylinder 1, and the liquid in the water tank 5lflows through the first one-way valve 6 to the cylinder 1 through the first pipe 52 under the action of atmospheric pressure, while the second one-way valve 7 is closed; at this time, when the user further presses the pressure rod handle 32, the connecting rod 4 rotates around the bottom fulcrum, the pressure rod head 31 drives the piston 2 to move down in the cylinder 1, and the liquid in the cylinder 1 is pressurized to flow through the second one-way valve 7 through the second pipe 53 to the water separator 8. At the same time, the first one-way valve 6 is closed; the liquid flows into the powder bowl 11 after being dispersed by the water separator 8; the liquid soaks the compacted brewing material in the powder bowl 11, and filters through the compacted brewing material under sufficient pressure after preparing the raw materials and extracting some of them at the same time, they flow out through the through holes at the bottom of the powder bowl to obtain the extract.

In the present application, the brewing extraction equipment enables users to easily apply force to obtain huge liquid pressure and liquid pressure, and extract high-quality espresso coffee. The device is small and light, which can be disassembled and is easy to carry. The work of adding water and coffee powder is simple and convenient. There are few parts to be cleaned after use, and the cleaning work is simple and convenient.

Referring to FIG. 4, there is shown a structural block diagram of another brewing extraction equipment of the present application, the brewing extraction equipment further includes a bracket 9; the bracket 9 is arranged outside the bottom of the kettle body 5; the bracket 9 is used to fix and support the main part of the brewing extraction equipment. In addition, the bracket 9 can also be arranged at any height of the kettle body to fix and support the main part of the brewing extraction equipment. This application does not restrict this.

As shown in FIG. 4, the bracket 9 is provided between the bottom outside of the kettle body 5 and the upper outside of the water separator 8, for fixing and supporting the main part of the foaming extraction equipment for the convenience of users place a container under the powder bowl to pick up the extract to improve the user's operating efficiency.

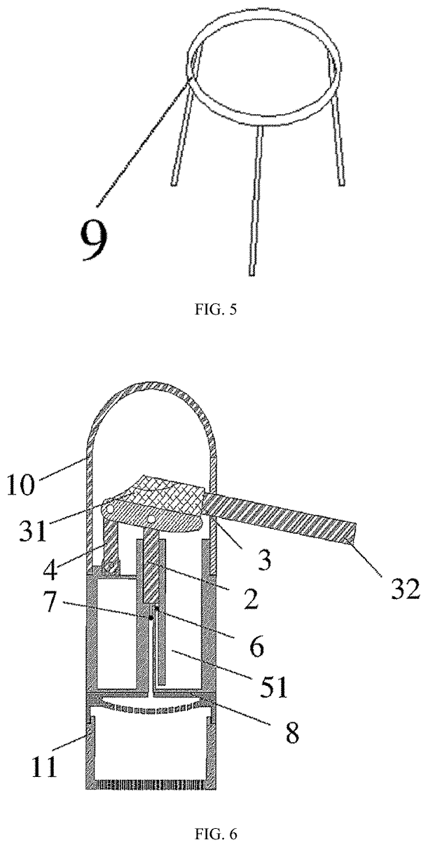

Referring to FIG. 5, there is shown a structural block diagram of a bracket 9 of the present application. As shown in FIG. 5, the bracket 9 may include three supporting feet, or of course, it may alternatively include four supporting feet. The present application does not limit it. Further, the structure of the above-mentioned bracket 9 is only an example of the present application, and other types of brackets can also be used to fix and support the main part of the brewing extraction equipment. The present application does not limit the structure of the bracket.

Referring to FIG. 6, there is shown a structural block diagram of another brewing extraction equipment of the present application, the brewing extraction equipment further includes a cover 10; the cover 10 is arranged above the kettle body 5.

Further, the brewing extraction equipment can also add a cover body 10 above the kettle body 5, which is convenient for the user to press the brewing extraction equipment to fix the brewing extraction equipment and strengthen the fixing performance of the device; when the cover 10 is removed, the user can hold the brewing extraction equipment by holding it.

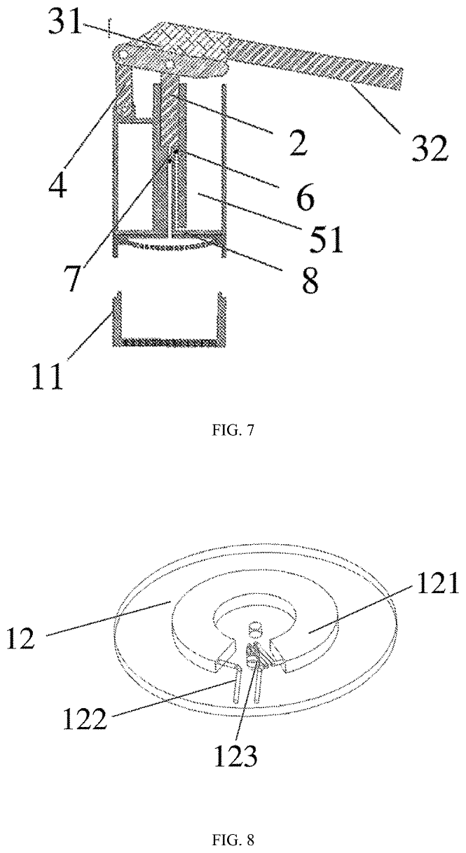

Referring to FIG. 7, there is shown another state schematic diagram of the brewing extraction equipment of the present application. As shown in FIG. 7, the powder bowl 1 can be separated from the water separator 8. The function of the water separator 8 is to disperse the liquid pressed by the cylinder and spray it evenly on the brewing material of the powder bowl 11, the bottom of the powder bowl 11 has at least one through hole; the extraction liquid can be discharged into a container through the through hole.

As shown in FIG. 7, the powder bowl 11 may include one or more through holes, and the extract can flow into a container through the through holes of the powder bowl 11. It should be noted that the connection between the powder bowl 11 and the water separator 8 can be threaded connection, snap connection, etc., which is not limited in this application.

Referring to FIG. 8, there is shown a block diagram of the internal structure of a heating device 12 of the present application. The brewing extraction equipment further includes a heating device 12 for heating the liquid in the water tank 51. The heating device 12 can be arranged on the outside of the bottom of the water tank and tightly integrated with the bottom of the water tank, or the heating device 12 can be directly used as the bottom of the water tank and tightly integrated with the side wall of the water tank to jointly form the water tank structure of the kettle body. It can be arranged on the outside of the side of the water tank, which is not limited in this application. The heating device 12 can include a heating element 121, a temperature controller 123, a wire 122, and the like. The heating element 121 is a high-resistance heating conductor wrapped by an insulating and thermally conductive material. Of course, the heating device 12 may also include certain necessary components such as a housing, a button, a control board, an external wire, and a plug, and the specific composition of the heating device is not limited in this application.

In addition, the heating design in FIG. 8 is an example of the present application, the heating device of the brewing extraction equipment can also be implemented by other heating design methods, and this application does not limit the specific heating implementation.

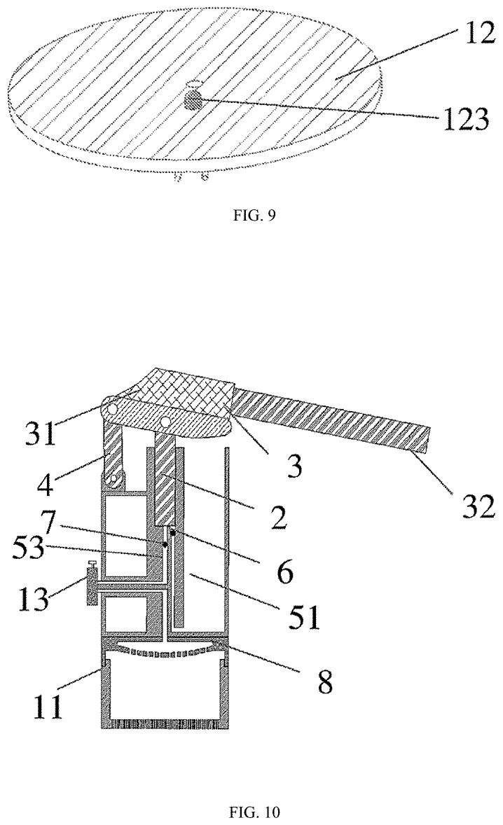

Referring to FIG. 9, there is shown a structural block diagram of the heating device 12 on the inner side of the bottom of the water tank. As shown in FIG. 9, the inner side of the bottom of the water tank includes a thermostat 123, which extends into the inside of the water tank. The temperature controller 123 is used to detect the temperature of the liquid in the water tank 51 to control the opening and closing of the heating circuit.

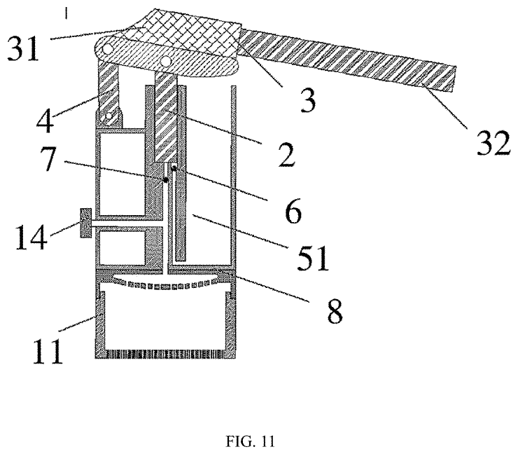

Referring to FIG. 10, there is shown a structural block diagram of another brewing extraction equipment of the present application, the kettle body 5 is also provided with a constant pressure water valve 13; the constant pressure water valve 13 and the second the pipe 53 are connected to each other; the constant pressure water valve 13 is used for when the pressure rod handle 32 is pressed down, the connecting rod 4 rotates around the bottom fulcrum, and the pressure rod head 31 drives the piston 2 downward in the cylinder 1 when moving, the liquid in the cylinder 1 is pressurized and flows through the second one-way valve 7 to the water separator 8 to adjust the pressure of the liquid. After the liquid flows out of the second one-way valve 7, it first passes through the constant pressure water valve 13 and then reaches the water separator 8. During the series connection process, the constant pressure water valve 13 adjusts the water pressure, so that the liquid pressure in the water separator 8 remains constant.

In actual application to this application, a constant pressure water valve 13 can be added to the second pipe 53 of the brewing extraction equipment, and the constant pressure water valve 13 can achieve the technical effect of adjusting the pressure of the liquid, specifically the constant pressure water valve 13 may include an adjusting knob, and the pressure of the liquid when the second one-way valve 7 flows to the water separator 8, is adjusted by the adjusting knob. The constant pressure water valve 13 is arranged on the kettle body and communicates with the second pipe 53, and its relative position with the pressure rod 3 is not limited.

Referring to FIG. 11, there is shown a structural block diagram of another brewing extraction equipment of the present application, the kettle body 5 is also provided with a water pressure gauge 14; the water pressure gauge 14 and the second pipe 53 are connected to each other. the water pressure gauge 14 is used when the pressure rod handle 32 is pressed down, the connecting rod 4 rotates around the bottom fulcrum, the pressure rod head 31 drives the piston 2 to move downward in the cylinder 1, so when the liquid in the cylinder 1 is under pressure and flows through the second one-way valve 7 to the water separator 8, the pressure of the liquid is measured. After the liquid flows out of the second one-way valve 7, part of it flows into the water pressure gauge 14, and the other part flows into the water separator 8. The two are connected in parallel, so that the pressure of the liquid monitored in the water pressure gauge 14 is equal to the pressure of the liquid in the water separator 8.

Further applied to this application, a water pressure gauge 14 can be added to the second pipe 53 of the brewing extraction equipment, and the water pressure gauge 14 can realize the function of observing the liquid pressure when the user presses the pressure rod handle 32. It is sufficient that the water pressure gauge 14 is arranged on the kettle body and communicates with the second pipe 53, and its relative position with the pressure rod 3 is not limited.

The various embodiments in this specification are described in a progressive manner, and each embodiment focuses on the differences from other embodiments, and the same or similar parts between the various embodiments can be referred to each other.

Although the preferred embodiments of the embodiments of the present invention have been described, those skilled in the art can make additional changes and modifications to these embodiments once they learn the basic creative concept. Therefore, the appended claims are intended to be interpreted as including the preferred embodiments and all changes and modifications falling within the scope of the embodiments of the present invention.

Finally, it should be noted that in this article, relational terms such as first and second are only used to distinguish one entity or operation from another entity or operation, and do not necessarily require or It implies that there is any such actual relationship or order between these entities or operations. Moreover, the terms “include”, “include” or any other variants thereof are intended to cover non-exclusive inclusion, so that a process, method, article or terminal device including a series of elements not only includes those elements, but also includes those that are not explicitly listed. Other elements listed, or also include elements inherent to this process, method, article or terminal device. If there are no more restrictions, the element defined by the sentence “including a . . . ” does not exclude the existence of other same elements in the process, method, article or terminal device that includes the element.

A brewing and extraction device provided by the present invention is described in detail above. Specific examples are used in this article to illustrate the principles and implementation of the present invention. The description of the above examples is only used to help understand the present invention. The method of the invention and its core idea; at the same time, for those of ordinary skill in the art, according to the idea of the present invention, there will be changes in the specific implementation and the scope of application. In summary, the content of this specification should not be understood to limit the present invention.

1. A brewing extraction equipment, comprising:
a cylinder, a piston, a pressure rod, a connecting rod, a kettle body, a first one-way valve, a second one-way valve, a water separator and a powder bowl, the pressure rod including a pressure rod head and a pressure rod handle, the kettle body including a water tank, a first pipe and a second pipe;
wherein the connecting rod is connected to the pressure rod head; the pressure rod head is connected to one end of the piston, the piston is arranged in the cylinder, the water tank is connected to a bottom of the cylinder through the first pipe, the first one-way valve is located in the first pipe, and the cylinder is also connected to the water separator through the second pipe provided at the bottom; the second one-way valve is located in the second pipe;
wherein when the pressure rod handle is pulled up, the pressure rod head drives the piston to move upward in the cylinder, the liquid in the water tank flows to the cylinder through the first one-way valve under the action of atmospheric pressure, while the second one-way valve is closed; wherein when the pressure rod handle is pressed down, the pressure rod head drives the piston to move downward in the cylinder, the liquid in the cylinder is pressurized to flow to the water separator through the second one-way valve, and first one-way valve is closed; wherein the liquid flows into the powder bowl after being dispersed by the water separator; the liquid soaks the compacted brewing materials in the powder bowl to obtain an extract.

2. The brewing extraction equipment according to claim 1, wherein the brewing extraction equipment further comprises a bracket, the bracket is arranged on the outside of the bottom of the kettle body, and the bracket is used to fix and support the main part of the brewing extraction equipment.

3. The brewing extraction equipment according to claim 1, wherein the brewing extraction equipment further comprises a cover, and the cover is arranged above the kettle body.

4. The brewing extraction equipment according to claim 1, wherein the powder bowl is connected to the water separator, and the bottom of the powder bowl has at least one through hole, and the powder bowl is used for filling the raw material is brewed and the liquid is high-pressure filtered through the brewing raw material through the bottom through hole to obtain an extract.

5. The brewing extraction equipment according to claim 1, wherein the brewing extraction equipment further comprises a heating device; wherein the heating device is arranged at the bottom or the side of the water tank, and the heating device is used for heating the liquid in the water tank.

6. The brewing extraction equipment according to claim 1, wherein the kettle body is further provided with a constant pressure water valve;
wherein the constant pressure water valve is connected to the second pipe, the constant pressure water valve is used for when the pressure rod handle is pressed down, the pressure rod head drives the piston to move down in the cylinder, and the liquid in the cylinder is pressurized to flow through the second one-way valve to the water diversion adjust the pressure of the liquid during the process of the device.

7. The brewing extraction equipment according to claim 1, wherein the kettle body is further provided with a water pressure gauge; wherein the water pressure gauge is connected to the second pipe, the water pressure gauge is used in the process that when the pressure rod handle is pressed down, the pressure rod head drives the piston to move down in the cylinder, and the liquid in the cylinder is pressurized to flow to the water separator through the second one-way valve, measure the pressure of the liquid.
